(19) United States
(12) Patent Application Publication
(10) Pub. No.: US 2025/0113948 A1
(43) Pub. Date: Apr. 10, 2025

(54) BURNER ASSEMBLY THAT PRODUCES A BLUE FLAME

(71) Applicant: Boil Boss, L.L.C., Harahan, LA (US)

(72) Inventor: Robert T. Lapeyre, New Orleans, LA (US)

(21) Appl. No.: 18/908,322

(22) Filed: Oct. 7, 2024

Related U.S. Application Data
(60) Provisional application No. 63/543,198, filed on Oct. 9, 2023.

(51) Int. Cl. A47J 37/12; A47J 36/26; F23D 14/20; F23D 23/00; F23K 5/00; F23Q 3/00

(52) U.S. Cl. CPC A47J 37/1247; A47J 36/26; F23D 14/20; F23D 23/00; F23K 5/005; F23Q 3/008; F23D 2207/00

(57) ABSTRACT

A burner assembly for an outdoor cooker or a commercial fryer has a jet tube into which gas is injected by a nozzle on an angle oblique to the centerline of the jet tube. The nozzle is supplied gas through a manifold having gas ports. One port serves as an inlet through which gas is supplied. Another port serves as an outlet feeding gas to the nozzle. The nozzle has an exit orifice that is positioned closer to the wall of the jet tube than to the tube's centerline to minimize blockage of air into the jet tube. The oblique injection of gas and minimized air blockage help the burner assembly maintain a high-temperature blue flame.

### CROSS-REFERENCE TO RELATED APPLICATIONS

This application claims the benefit of co-pending U.S. Provisional Patent Application No. 63/543,198, filed Oct. 9, 2023.

### TECHNICAL FIELD

The invention relates generally to cooking and heating and, more particularly, to burner assemblies for commercial deep fryers, for outdoor burners heating large pots, and for other high-temperature heating applications.

### BACKGROUND

Outdoor cooking stands of the jet-burner type are often used to support and heat large pots in which, for example, seafood is boiled, poultry is fried, or beer is brewed. Typical outdoor burners comprise a pot-supporting stand with a burner assembly including a jet tube directing a flame at high pressure upward against the bottom of a supported pot. Commercial deep fryers use jet tubes to heat cooking oil in a fry tank.

A blue flame indicates complete combustion; a yellow or red flame indicates incomplete combustion. Incomplete combustion occurs when the supply of air (oxygen) is too low. The resulting yellow or red flame is at a much lower temperature than the temperature of a blue flame. So heating and cooking time is increased, more fuel is used, and, in an outdoor burner, soot builds up on the bottom of the pot.

### SUMMARY

A burner assembly comprises a jet tube, a manifold, and a nozzle. The jet tube has a tubular wall that defines an open first end and an open second end and has a centerline that intersects the open first end and the open second end. The manifold has an inlet and an outlet. The nozzle is connected to the manifold's outlet and extends into the jet tube proximate the open first end and is oriented to inject gas received through the inlet into the jet tube on an angle oblique to the centerline.

### BRIEF DESCRIPTION OF THE DRAWINGS

FIG. 1 is an isometric view of an outdoor burner with a single jet tube and a burner assembly for producing a blue flame.

FIG. 2 is an isometric view of one version of a burner assembly with electronic ignition usable in an outdoor burner as in FIG. 1.

FIG. 3 is an isometric view of another version of a burner assembly usable in an outdoor burner as in FIG. 1.

FIG. 4 is a top plan view of the burner assembly of FIG. 3.

FIG. 5 is an isometric view of the manifold in the burner assembly of FIG. 3.

FIG. 6 is a side schematic showing the geometric arrangement of the jet tube and the gas nozzle in a burner assembly as in FIG. 3 and FIG. 4.

FIG. 7 is an isometric view of a linear arrangement of multiple burner assemblies as in FIG. 2.

FIG. 8 is an isometric view of a rectangular cooker heated by the linear arrangement of burner assemblies of FIG. 7.

FIG. 9 is an isometric view of multiple burner assemblies as in FIG. 2 in a two-line configuration.

FIGS. 10A and 10B are isometric and side elevation views of a burner assembly including a jet channel with multiple gas nozzles.

FIGS. 11A and 11B are isometric and rear elevation views of a commercial fryer using a burner assembly as in FIG. 3 or FIG. 6.

FIG. 12 is an oblique view of another version of a burner assembly embodying features of the invention with the nozzle assembly omitted to simplify the drawing.

FIG. 13 is a partly cutaway view of the burner assembly of FIG. 12.

FIG. 14 is a cutaway side elevation view of the burner assembly of FIG. 12 with the nozzle assembly.

### DETAILED DESCRIPTION

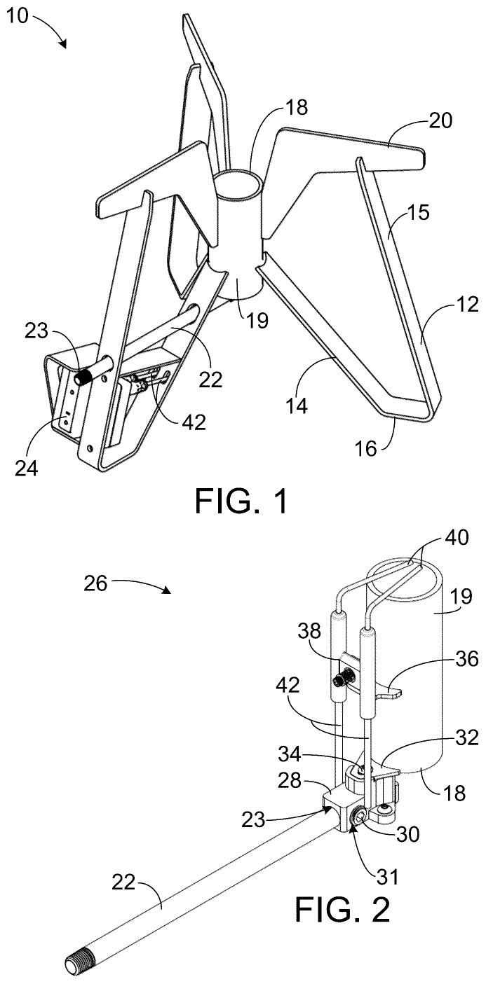

An outdoor burner is shown in FIG. 1. The burner 10 has three legs 12. Each leg 12 has two branches 14, 15 extending upward from a bottom base 16 that sits on the ground. One end of the inner branch 14 is attached to a central jet tube 18 having a tubular wall 19. The end of the outer branch 15 is attached to a pot support 20. The legs 12 and the pot supports 20 form a stand for a pot. A boiling or frying pot sits on the three pot supports 20. A gas pipe 22 extends from the jet tube 18. A supply of gas, such as a propane tank (not shown), is connected to the end 23 of the gas pipe 22 by a hose (not shown). Also mounted on one of the legs 12 is an electronic ignition unit 24.

FIG. 2 shows a burner assembly 26 usable in the outdoor burner 10 of FIG. 1. The threaded inner end of the gas pipe 22 is screwed into a port 23 serving as an inlet in a pipe fitting serving as a manifold 28. Gas plugs 30 are screwed into unused ports 31 in the sides of the manifold 28 to form a single-output manifold. The port 23 used as an inlet and the unused ports 31 can, in configurations with multiple interconnected burner assemblies, serve as either inlets or outlets of the manifold 28.

Attachment structure is provided by a flange 32 welded to the tubular wall 19 of the jet tube 18 at the bottom and fastened to the manifold 28 by a screw or bolt 34. An optional second flange 36 extending from the outer side of the jet tube 18 between its top and bottom is used to attach an optional electrode assembly 38 to the jet tube. Electrode-assembly electrodes 40 extend over the open upper end of the jet tube 18. Wires 42 connect the electrodes 40 to the electronic ignition unit 24 shown in FIG. 1. The ignition unit 24 (FIG. 1) generates high-voltage pulses across the electrodes 40 that produce arcs that ignite the gas flowing up the jet tube 18. If an electrode assembly 38 and an electronic ignition unit 24 are not used, the gas can be ignited manually by a match, lighter, or other flame source.

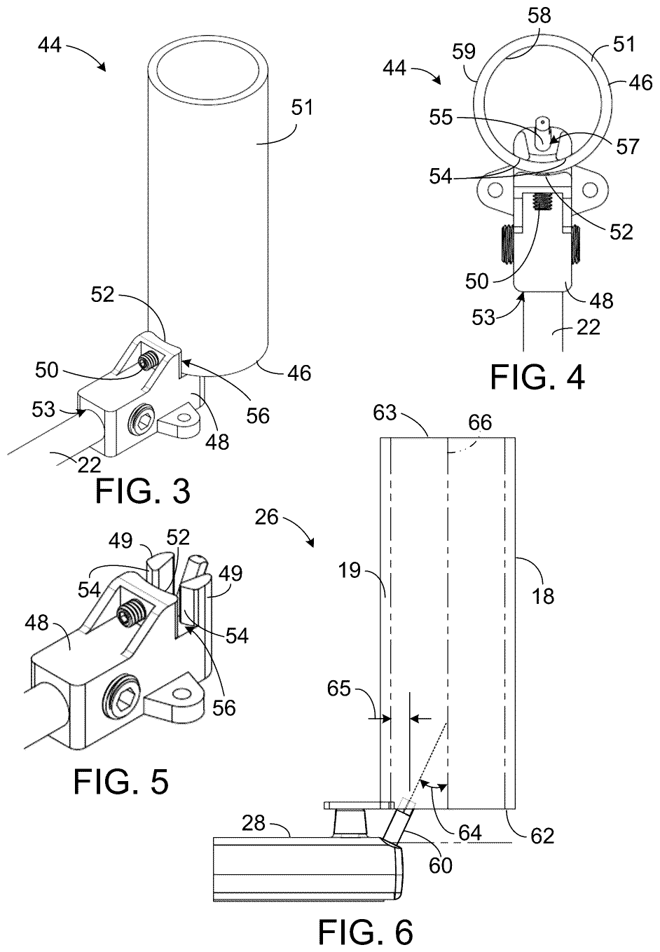

A slightly different burner assembly 44 is shown in FIGS. 3 and 4. In this version a jet tube 46 is fastened to a manifold 48 by attachment structure provided by a set screw 50 that is threaded through a curved vertical wall 52. As shown in FIG. 5, wall segments 54 formed on posts 49 extending upward from the manifold 48 face the curved wall 52 across a gap 56, in which the bottom edge of the tubular wall 51 of the jet tube 46 is received. The set screw 50 is tightened against the jet tube 46 to hold it in place. The wall segments 54 can be flat or they can be curved to match the curvature of the inner side 58 of the jet tube's tubular wall 51, and the curvature of the curved wall 52 can match the curvature of the outer side 59 of the jet tube's tubular wall.

The gas pipe 22 is connected to a port 53 on the manifold 48. A nozzle 55 is connected to an outlet 57 of the manifold 48. Gas flows from the gas pipe 22 in the port 53 through an interior channel in the manifold 48 to the nozzle 55 protruding from the outlet 57.

As shown in FIG. 6, a nozzle 60 extends from the manifold 28 of FIG. 2 into the jet tube 18 at an open bottom end 62. The circular cylindrical tubular wall 19 gives the jet tube 18 a centerline 66 that intersects both the open bottom end 62 and an open top end 63. Unlike other burner assemblies, in which the nozzle is positioned at the center of the bottom opening of a jet tube and oriented to eject gas along the centerline of the cylindrical tube, the nozzle 60 is positioned to inject gas into the jet tube 18 at an oblique angle 64 to the centerline 66 from a position closer to the jet tube's wall 19 than to the centerline. In this way, the nozzle 60 and manifold 28 block less of the bottom open end 62 so that more air can enter the jet tube 18. (The area of the open bottom end that is not blocked is better illustrated in FIG. 4 for the other burner assembly 44. It's clear that less than half of the open bottom end is blocked.) The oblique orientation of the nozzle 60 means that the jet of gas exiting the nozzle is directed toward the jet tube's tubular wall 19 across the centerline 66 and not parallel to the tubular wall along the centerline 66. The turbulence in the jet tube 18 due to the oblique orientation of the nozzle 60 increases the mixing of the gas with air. And together with the increased supply of air through the minimally blocked open bottom end 62 of the jet tube 18, the burner assembly 26 exhibits better combustion and produces a blue flame exiting the tube's open top end 63 to heat a boiling or frying pot more efficiently at a high temperature.

The oblique angle 64 can range from about 5° to about 45° to achieve the desired effect. Of course, the angle may be different for jet tubes or other combustion chambers having different dimensions. The distance 65 between the nozzle's orifice and the inside wall of the jet tube 18 can range from about 0.25 inches to about 3 inches depending on the diameter of the jet tube 18. As an example, for a jet tube having an inner diameter of about 2 inches, the distance 65 between the nozzle's orifice and the inside wall could be about 0.5 inches or less.

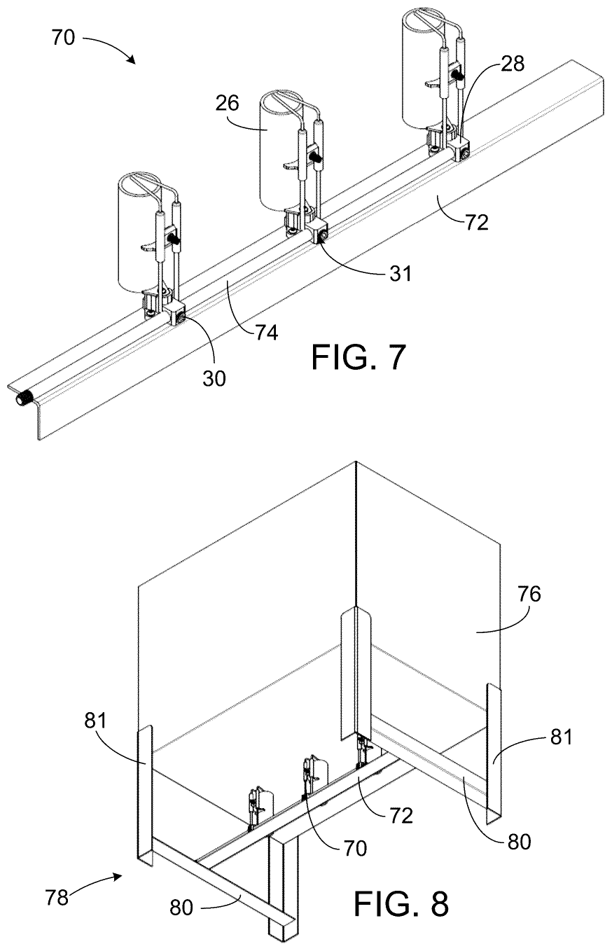

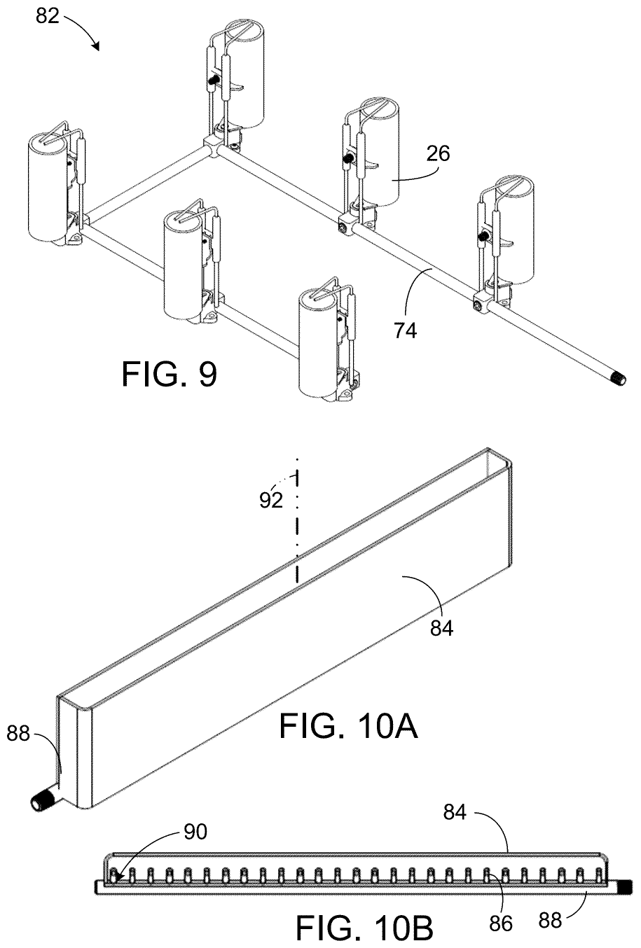

FIG. 7 shows a linear arrangement 70 of three burner assemblies 26 as in FIG. 2 mounted on a rail 72. Gas pipe segments 74 supply gas to the burner assemblies 26 in series. Gas plugs 30 plug the unused ports 31 in the manifolds 28. The linear rail-mounted arrangement 70 can be used for a cooking chamber 76 in a rectangular cooker 78 as in FIG. 8. The rail 72 is supported below the cooking chamber 76 at opposite ends on angled rails 80 spanning legs 81. For a larger rectangular cooker, a multi-line arrangement 82 as in FIG. 9 can be used instead. In this example, the burner assemblies 26 are arranged in a rectangular array of multiple rows, in this case two rows, by the gas pipe segments 74.

The elongated jet tube 84 in FIGS. 10A and 10B has a rectangular cross section in a plane parallel to its open top and bottom ends. The elongated rectangular jet tube 84 accommodates a series of nozzles 86 spaced apart along a gas pipe 88. Outlets 90 in the gas pipe 88, which serves as a manifold, emit gas into the nozzles 86. This linear arrangement differs from the linear arrangement 70 in FIG. 7 in that, instead of having multiple single-nozzle manifolds, it uses a single manifold to service multiple nozzles. It's also possible to make multiple-nozzle manifolds with spoke-like arms out of pipes or by casting for supplying gas to nozzles over an area rather than along a single line. Like the nozzle 60 of FIG. 6, the nozzles 86 of FIG. 10B are oriented to inject gas into the rectangular jet tube 84 oblique to the tube's centerline 92. And, similarly, the orifices of the nozzles 86 are offset from the centerline 92 to lessen the blockage of air through the open bottom end of the jet tube 84.

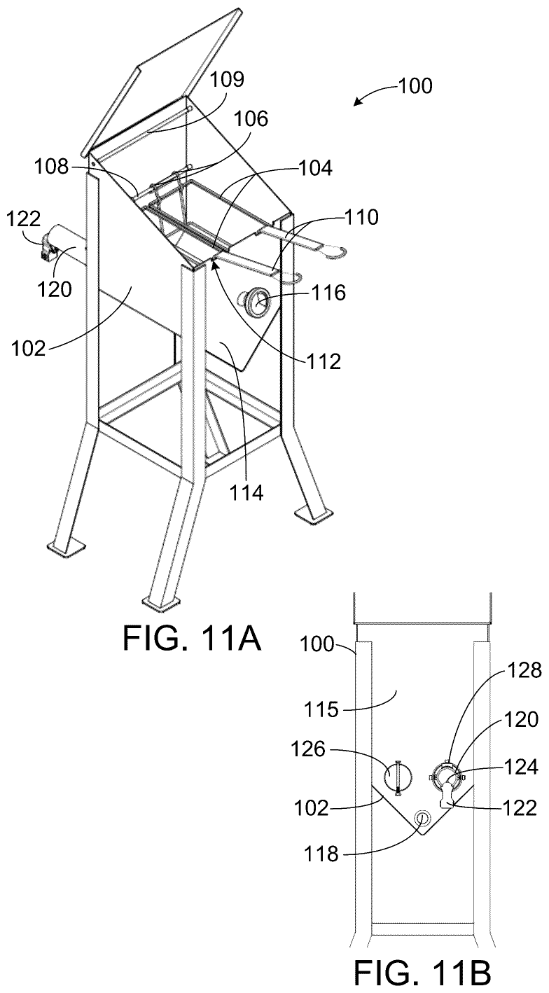

The burner assembly of FIG. 3 or of FIG. 6 is shown in a commercial fryer 100 in FIGS. 11A and 11B. The fryer 100 has an oil-filled tank 102 into which metal baskets 104 are inserted to deep-fry food in the baskets. Hooks 106 at one end of the baskets 104 hook onto a lower bar 108 spanning the width of the tank 102 to suspend the baskets into the heated cooking oil for frying. The hooks 106 are hooked onto an upper bar 109 when the baskets 104 are not in use. Handles 110 at the other end of the baskets 104 rest on notches 112 at the top of the front wall 114 of the fryer 100. A temperature gauge 116 is mounted to the front wall 114. A drain 118 at the bottom of the tank 102 is used to drain spent oil from the tank through a rear wall 115. A burner assembly including a jet tube 120, a manifold 122, and a nozzle 124 directs a flame into the mouth at one end of a heating tube (not shown) that runs through the bottom of the tank 102 to an exhaust port 126 on the rear wall 115. Air heated by the flame and conducted through the heating tube transfers heat through the walls of the tube and into the oil to fry food in the baskets 104. Connection structure 128 fastens the jet tube 120 to the rear wall 115 at the mouth of the heating tube. The oblique and offset arrangement of the nozzle 124 and the manifold 122 with respect to the jet tube 120 is the same as is shown in FIG. 6 to produce a high-temperature blue flame that results in the efficient heating of the cooking oil in the tank 102. The only difference is that the jet tube 120 is horizontal for the fryer 100 and vertical for the outdoor burner.

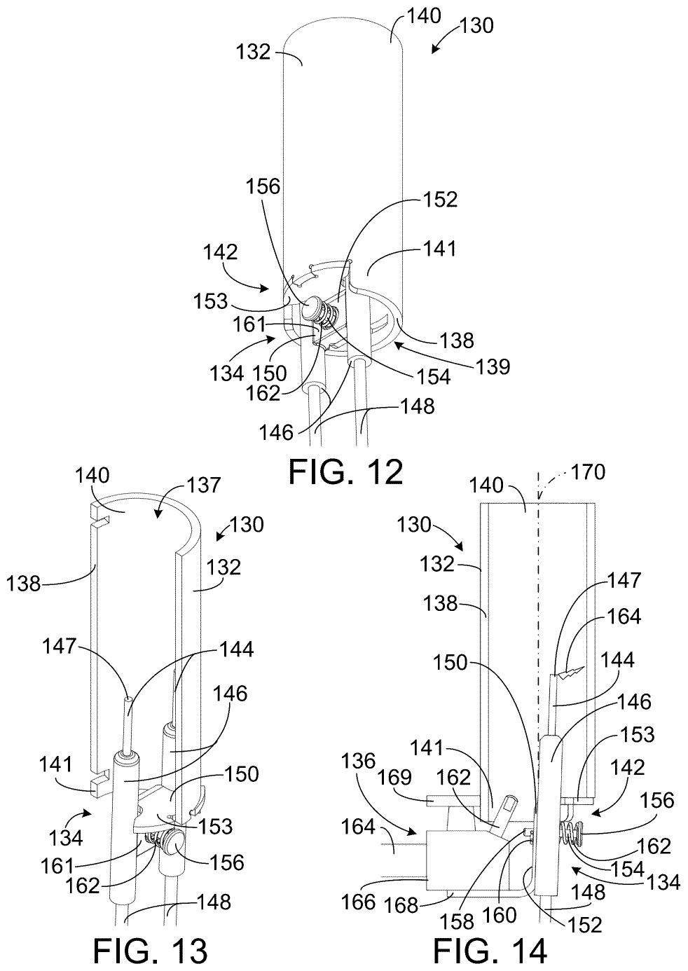

Another version of a burner assembly is shown in FIGS. 12-14. The burner assembly 130 includes a jet tube 132, an electrode assembly 134, and a nozzle assembly 136. (The nozzle assembly is shown only in FIG. 14.) The jet tube 132 has a tubular wall 138 that extends end to end from a top 140 to a bottom 141. The jet tube 132 has top and bottom openings 137, 139. A notch 142 in the wall 138 at the bottom 141 provides space for the attachment of the electrode assembly 134. The electrode assembly 134 includes two electrodes 144 extending from ceramic insulators 146 to distal ends 147. Wires 148 are connected to the electrodes 144 at junctions inside the surrounding insulators 146. A bracket 150 has a vertical portion 152 that is attached to the two ceramic insulators 146 to space them apart. A horizontal portion 153 of the bracket 150 extends from the top of the vertical portion 152 and is welded to the wall 138 at the notch 142 in the bottom 141 of the jet tube 132. The horizontal portion 153 occludes a portion of the bottom opening 139 to increase the gas-to-air ratio in the jet tube 132 and to serve as a heat shield.

A pin 154 having a head 156 at one end extends through a hole in the vertical portion 152 of the bracket 150. The unheaded end 158 of the pin 154 is welded or otherwise affixed to the interior face 160 of the vertical portion 152. A coil spring 162 surrounds the shaft of the pin 154 between the pin's head 156 and the outer face 161 of the bracket 150. The spring 162 gives the ceramic insulators 146 from which the electrodes 144 extend a displacement range to comply with the expansion of the bracket 150 with temperature to prevent the insulators from cracking. When energized, the two electrodes 144 produce arcs 164 to the jet tube's wall 138 to ignite the gas injected into the tube 132 by the nozzle assembly 136.

The nozzle assembly 136 includes a nozzle 162, a gas pipe 164, and a manifold 166. The gas pipe 164 is connected to the manifold's input. The nozzle extends from the manifold's output into the jet tube 132 at the bottom 141. The manifold 166 is supported at its bottom side on a lower horizontal portion 168 of the bracket 150 and at its top side from a tab 169 protruding from the outer side of the jet tube 132. The distal ends of the nozzle 162 and the electrodes 144 are offset from the centerline 170 of the jet tube 132. Like the nozzle 60 of FIG. 6, the nozzle 162 injects gas into the jet tube 132 on an angle to aim the gas toward the electrodes 144 on the other side of the jet tube's centerline 170.

Although the burner assembly has been disclosed in detail with respect to outdoor burners and commercial fryers, it can be used in other high-temperature applications, such as heating asphalt, for example.

What is claimed is:

1. A burner assembly comprising:
a jet tube having a tubular wall defining an open first end and an open second end of the jet tube and a centerline intersecting the open first end and the open second end;
a manifold having an inlet and an outlet;
a nozzle connected to the manifold's outlet and extending into the jet tube proximate the open first end and oriented to inject gas received through the inlet into the jet tube on an angle oblique to the centerline.

2. The burner assembly of claim 1 wherein the nozzle extends through the open first end into the jet tube.

3. The burner assembly of claim 1 wherein the nozzle has an orifice positioned closer to the tubular wall than to the centerline of the jet tube.

4. The burner assembly of claim 1 wherein the angle oblique to the centerline is between about 5° and about 45°.

5. The burner assembly of claim 1 comprising a gas pipe connected to the inlet of the manifold through which gas is supplied to the jet tube through the nozzle.

6. The burner assembly of claim 1 comprising a plurality of the burner assemblies of claim 1 and a plurality of gas pipe segments, wherein the manifolds in each burner assembly have multiple ports and wherein the gas pipe segments connect between the ports of consecutive manifolds to supply gas to the burner assemblies in series.

7. The burner assembly of claim 6 wherein the burner assemblies are arranged in more than one row.

8. The burner assembly of claim 1 wherein the jet tube has a rectangular cross section parallel to the open first and second ends and wherein the manifold comprises a gas pipe with multiple outlets supplying gas to multiple nozzles spaced apart along the gas pipe at the open first end of the jet tube.

9. The burner assembly of claim 1 wherein the manifold has multiple outlets supplying gas to multiple nozzles.

10. The burner assembly of claim 1 wherein the manifold and the nozzle block less than half the open first end of the jet tube.

11. The burner assembly of claim 1 comprising attachment structure on the manifold to fasten the jet tube to the manifold.

12. The burner assembly of claim 1 comprising an electrode assembly that includes:
an electrode;
an electronic ignition unit; and
a wire connecting the electrode to the electronic ignition unit;
wherein the ignition unit generates high-voltage pulses carried by the wire to the electrode to produce arcs that ignite the gas injected into the jet tube.

13. The burner assembly of claim 12 wherein the electrode assembly includes two electrodes and two wires connecting the two electrodes to the electronic ignition unit, wherein the electronic ignition unit's high voltage pulses are applied across the electrodes to produce arcs between the electrodes that ignite the gas.

14. The burner assembly of claim 13 wherein the two electrodes extend over the open second end of the jet tube.

15. The burner assembly of claim 12 wherein a distal end of the electrode resides within the jet tube and the electronic ignition unit's high voltage pulses are applied between the electrode and the jet tube to produce arcs between the electrode and the jet tube that ignite the gas.

16. The burner assembly of claim 15 wherein the electrode assembly is mounted to the jet tube at the open first end and wherein the electrode extends into the jet tube to the distal end through the open first end.

17. The burner assembly of claim 16 wherein the distal end of the electrode is closer to the tubular wall than to the jet tube's centerline.

18. The burner assembly of claim 15 wherein the electrode assembly includes a pair of electrodes extending into the jet tube through the open first end.

19. The burner assembly of claim 18 wherein the electrode assembly includes:
a pair of wires connected to the pair of electrodes at junctions;
a pair of ceramic insulators surrounding the junctions;
a bracket having a vertical portion attached to the ceramic insulators to space the ceramic insulators apart and a horizontal portion fastened to the jet tube's wall at the open first end;
wherein the horizontal portion occludes a portion of the open first end and serves as a heat shield.

20. The burner assembly of claim 19 wherein the electrode assembly includes:
a pin having a head at a first end and a shaft extending from the head to a second end;
a coil spring surrounding the shaft;
wherein the vertical portion of the bracket has an interior face and an outer face farther from the wall than the interior face;
wherein the pin extends through the horizontal portion of the bracket and the pin's second end is affixed to the interior face of the horizontal portion;
wherein the coil spring surrounds the shaft of the pin between the head of the pin and the outer face of the horizontal portion of the bracket to allow for expansion of the bracket with temperature to prevent the ceramic insulators from cracking.

21. An outdoor burner comprising a stand for supporting a pot and a burner assembly as in claim 1 supported on the stand for directing a blue flame to the bottom of the pot.

22. A fryer comprising a tank and a burner assembly as in claim 1 connected to the tank for heating cooking oil in the tank to deep-fry foods lowered into the tank.
